(19) United States
(12) Patent Application Publication
(10) Pub. No.: US 2020/0220119 A1
(43) Pub. Date: Jul. 9, 2020

(54) FILM-COVERED BATTERY, BATTERY PACK AND METHOD FOR MANUFACTURING THE FILM-COVERED BATTERY

(71) Applicant: NEC CORPORATION, Tokyo (JP)

(72) Inventors: Noboru YOSHIDA, Tokyo (JP); Kazuhiko INOUE, Tokyo (JP); Kenichi SHIMURA, Tokyo (JP); Makihiro OTOHATA, Tokyo (JP)

(73) Assignee: NEC CORPORATION, Tokyo (JP)

(21) Appl. No.: 16/645,005

(22) PCT Filed: Sep. 27, 2018
(86) PCT No.: PCT/JP2018/035925

§ 371 Date: Mar. 6, 2020

(30) Foreign Application Priority Data
Oct. 6, 2017 (JP) 2017-195805

(51) Int. Cl. H01M 2/02; H01M 2/08; H01M 10/04

(52) U.S. Cl. CPC H01M 2/0267; H01M 10/04; H01M 2/08

(57) ABSTRACT

A battery having a battery element with an outer package made of a film that includes a first portion having a first bottom wall and a first side wall rising from an outer peripheral end of the first bottom wall over an entire outer peripheral end of the first bottom wall, a second portion having a second bottom wall and a second sidewall rising from an outer peripheral end at least at a part of the outer peripheral end of the second bottom surface, and a joining portion in which outer peripheral portions of the first and second portions are joined when the battery element is between the first and second bottom walls and the first and second portions face each other, wherein the joining portion includes a sidewall joining portion in which the first and second sidewalls are joined and located outside a thickness range of the battery element.

### TECHNICAL FIELD

The present invention relates to a film-covered battery in which a battery element is enclosed in a package made of a film, a battery pack in which a plurality of film-covered batteries are stacked, and a method for manufacturing the film-covered battery.

### BACKGROUND ART

Conventionally, as a film-covered battery using a film, a film-covered battery in which a battery element is sealed with a laminated film in which a metal layer and a heat-fusible resin layer are laminated is known. The battery element is surrounded by the laminated film, and then sealed by joining the opposing surfaces of the laminated film at the outer peripheral portion of the laminated film by heat sealing or the like in a state where lead terminals of a positive electrode and a negative electrode connected to the battery element are drawn out from the laminated film.

In this type of film-covered battery, the battery is usually surrounded by two films by sandwiching the battery element from both sides in the thickness direction. Therefore, the joining portion formed by bonding the surfaces of the films is formed so as to spread in the in-plane direction perpendicular to the thickness direction of the battery element. As a result, a footprint of the film-covered battery (occupancy area of the film-covered battery when the film-covered battery is projected from the thickness direction of the battery element) is increased by the area of the joining portion. The increase in the footprint causes a decrease in a volume energy density of the film-covered battery.

Patent Literature 1 (Japanese Patent Application Laid-Open No. 2003-223874) discloses a film-covered battery in which a battery element is covered by a first and a second outer packaging films, wherein the first outer packaging film has a concave portion accommodating a battery element and a first bent portion formed by bending the periphery of the concave portion in a direction of the concave portion, the second outer packaging film has a second bent portion corresponding to the first bent portion, and the first and the second bent portions are bonded.

Thus, it is possible to suppress an increase in the footprint of the film-covered battery by forming the first bent portion and the second bent portion on the first outer packaging film and the second outer packaging film, respectively, and bonding them.

### CITATION LIST

### Patent Literature

Patent Literature 1: Japanese Patent Application Laid-Open No. 2003-223874

### SUMMARY OF INVENTION

### Technical Problem

However, in the film-covered battery described in Patent Literature 1, since the first bent portion is formed by bending the periphery of the concave portion in the direction of the concave portion, the first outer packaging film is bent at an angle close to 180 degrees at the first bent portion. Such a sharp bend can damage a metal layer of the laminated film. When the metal layer of the laminated film is damaged, the sealing property of the battery element is reduced, and in some cases, an electrolyte may leak.

Moreover, in the film-covered battery described in Patent Literature 1, the positive and negative electrode lead terminals are drawn out in a direction perpendicular to the thickness direction of the battery element, and the effect of the lead terminals on the footprint of the film-covered battery is not considered. As a result, the footprint is increased by the size of the lead terminals.

An object of the present invention is to provide a film-covered battery having a smaller footprint without adversely affecting the sealing performance of a battery element, a method for manufacturing the same, a battery pack in which a plurality of film-covered batteries are stacked, and a battery module.

### Solution to Problem

A film-covered battery according to the present invention comprises:

a battery element including at least one positive electrode and at least one negative electrode, and

an outer package made of a film configured to seal the battery element together with an electrolyte,

wherein the outer package comprises

(a) a first portion having a first bottom wall and a first side wall rising from an outer peripheral end of the first bottom wall over an entire outer peripheral end of the first bottom wall,

(b) a second portion having a second bottom wall and a second sidewall rising from an outer peripheral end at least at a part of the outer peripheral end of the second bottom surface, and

(c) a joining portion in which outer peripheral portions of the first portion and the second portion are joined to each other in a state where the battery element is located between the first bottom wall and the second bottom wall and the first portion and the second portion face each other, wherein the joining portion includes a sidewall joining portion in which the first sidewall and the second sidewall are joined and located outside a thickness range of the battery element.

Further, in a battery pack according to the present invention, a plurality of the film-covered batteries are stacked and connected in series and/or in parallel.

### Definition of Terms Used in this Specification

“Thickness of the battery element” means a dimension of the battery element in a direction perpendicular to a surface where the battery element is in contact with the bottom wall of the outer package.

“Footprint” means a occupancy area of the film-covered battery when the film-covered battery is projected from the thickness direction of the battery element

The “bottom wall” of the outer package means a flat portion of the outer package sandwiching the battery element from above and below.

The “sidewall” of the outer package means a portion of the outer package that rises from the outer peripheral end of the bottom wall, and a portion that extends at an angle from the rising portion is not included in the sidewall.

### Advantageous Effects of Invention

According to the present invention, it is possible to provide a film-covered battery having a smaller footprint without adversely affecting the sealing performance of a battery element, a method for manufacturing the same, a battery pack in which a plurality of film-covered batteries are stacked, and a battery module.

### BRIEF DESCRIPTION OF DRAWINGS

FIG. 1 is an exploded perspective view of a film-covered battery according to one embodiment of the present invention.

FIG. 2 is a schematic sectional view of a battery element shown in FIG. 1.

FIG. 3A is a perspective view showing a modified example of a drawn out position of a positive electrode terminal and a negative electrode terminal from a battery element.

FIG. 3B is a perspective view showing a modified example of the drawn out position of the positive electrode terminal and the negative electrode terminal from the battery element.

FIG. 3C is a perspective view showing a modified example of the drawn out position of the positive electrode terminal and the negative electrode terminal from the battery element.

FIG. 3D is a perspective view showing a modified example of the drawn out position of the positive electrode terminal and the negative electrode terminal from the battery element.

FIG. 3E1 is a perspective view of the film-covered battery having the battery element shown in FIG. 3A.

FIG. 3E2 is a perspective view of the film-covered battery having the battery element shown in FIG. 3B.

FIG. 3E3 is a perspective view of the film-covered battery having the battery element shown in FIG. 3C.

FIG. 3E4 is a perspective view of the film-covered battery having the battery element shown in FIG. 3D.

FIG. 4 is a schematic sectional view of the film-covered battery shown in FIG. 1 cut at a position of a terminal.

FIG. 5 is a perspective view showing a modified example of the structure of the outer package in one embodiment of the present invention.

FIG. 6 is a perspective view showing a modified example of the structure of the outer package in one embodiment of the present invention.

FIG. 7 is a schematic sectional view showing a battery pack and a battery module according to one embodiment of the present invention.

FIG. 8A is a schematic sectional view showing a battery pack and a battery module according to one embodiment of the present invention.

FIG. 8B is a perspective view showing an appearance of a battery module according to one embodiment of the present invention.

FIG. 9 is a schematic sectional view illustrating an example of connection of a battery pack according to an embodiment of the present invention.

FIG. 10 is a schematic diagram illustrating an example of an electric vehicle including a secondary battery.

FIG. 11 is a schematic diagram illustrating an example of a power storage device including a secondary battery.

### DESCRIPTION OF EMBODIMENTS

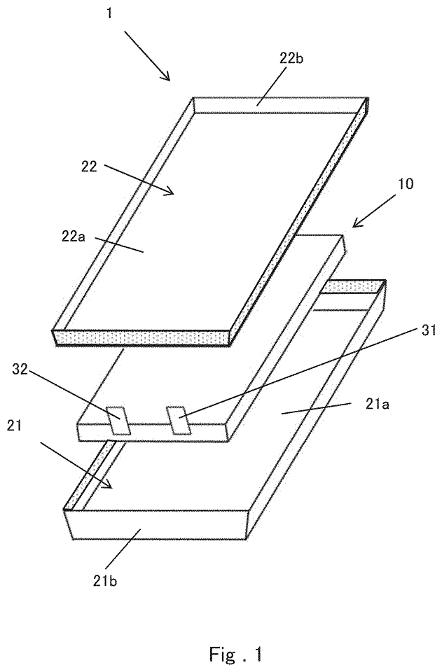

Referring to FIG. 1, an exploded perspective view of a film-covered battery 1 according to one embodiment of the present invention is shown, which comprises a battery element 10 and an outer package made of a film enclosing the battery element 10 together with an electrolyte. The outer package has a first portion 21 and a second portion 22 that enclose the battery element 10 from both sides in the thickness direction thereof and seal outer circumferential portions thereof to thereby seal the battery element 10 and the electrolyte. A positive electrode terminal 31 and a negative electrode terminal 32 are respectively connected to the battery element 10 with protruding part of them from the casing.

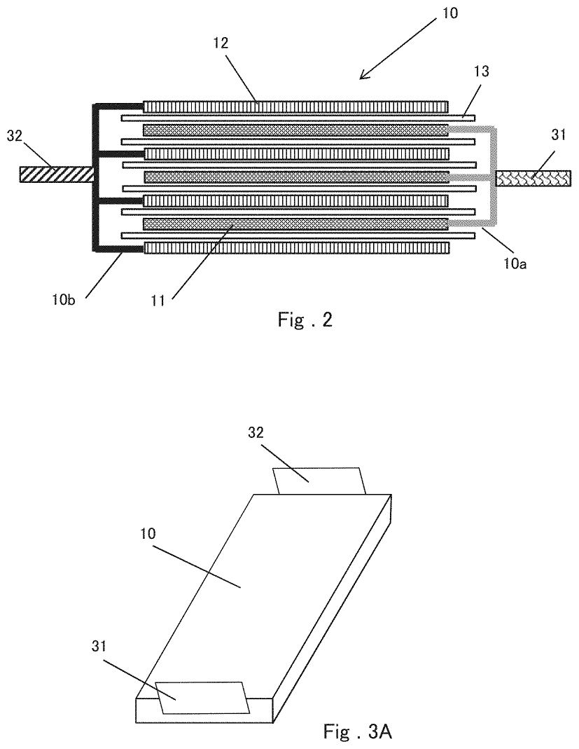

As shown in FIG. 2, the battery element 10 has a configuration in which a plurality of positive electrodes 11 and a plurality of negative electrodes 12 are disposed to face each other so as to be alternately positioned (In FIG. 2, in order to simply show the structure, the positive electrode terminal 31 and the negative electrode terminal 32 are shown as being drawn out in opposite directions.). In addition, a separator 13 is disposed between the positive electrode 11 and the negative electrode 12 to ensure ion conduction between the positive electrode 11 and the negative electrode 12 and to prevent a short circuit between the positive electrode 11 and the negative electrode 12. However, when the outermost layer of at least one of the positive electrode 11 and the negative electrode 12 has an insulating layer that can be used as a substitute for the separator 13, the separator 13 may be unnecessary.

Each of the positive electrode 11 and the negative electrode 12 has a current collector formed of, for example, a metal foil, and an active material layer formed on one or both surfaces of the current collector. The active material layer is formed, for example, in a rectangular shape in plan view, and the current collector has a shape having an extended portion extending from a region where the active material layer is formed.

The extended portion of each positive electrode 11 is collected and welded together to form a positive electrode tab 10a, and the positive electrode tab 10a is electrically connected to the positive electrode terminal 31. Similarly, the extended portion of each negative electrode 12 is collected and welded together to form a negative electrode tab 10b, and the negative electrode tab 10b is electrically connected to the negative electrode terminal 32.

Since the battery element 10 having a planar laminated structure as illustrated has no portion having a small radius of curvature (region close to a winding core of a winding structure), the battery element 10 has an advantage that it is less susceptible to the volume change of the electrode due to charging and discharging as compared with the battery element having a wound structure. That is, the battery element having a planar laminated structure is effective for an electrode assembly using an active material that is liable to cause volume expansion.

In the embodiment shown in FIG. 1, the positive terminal 31 and the negative terminal 32 are drawn out from the same side of the battery element 10, but the positions where the positive terminal 31 and the negative terminal 32 are drawn out may be arbitrary.

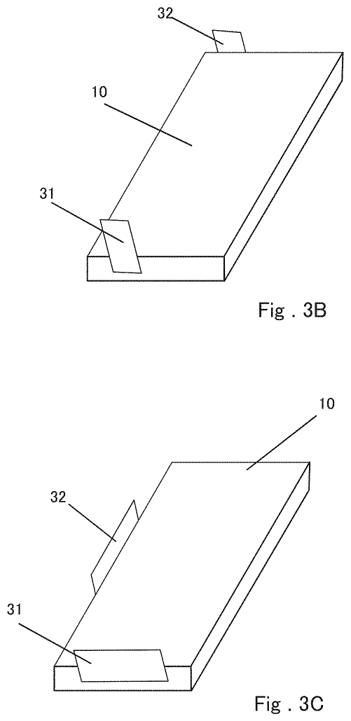

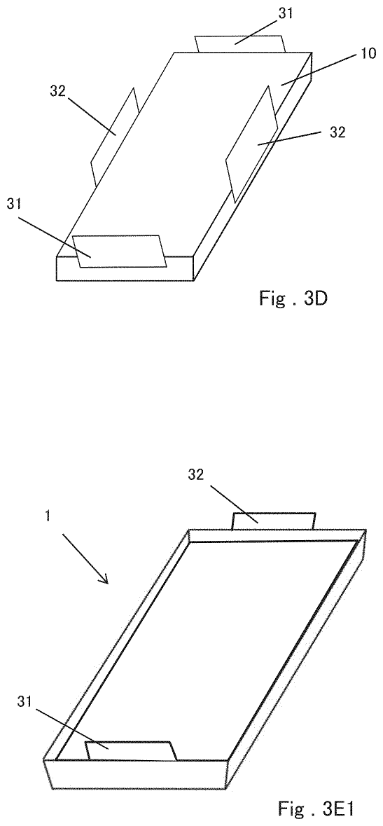

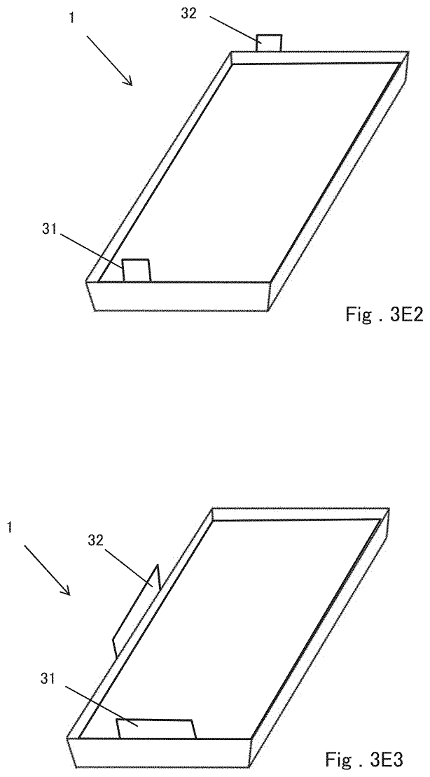

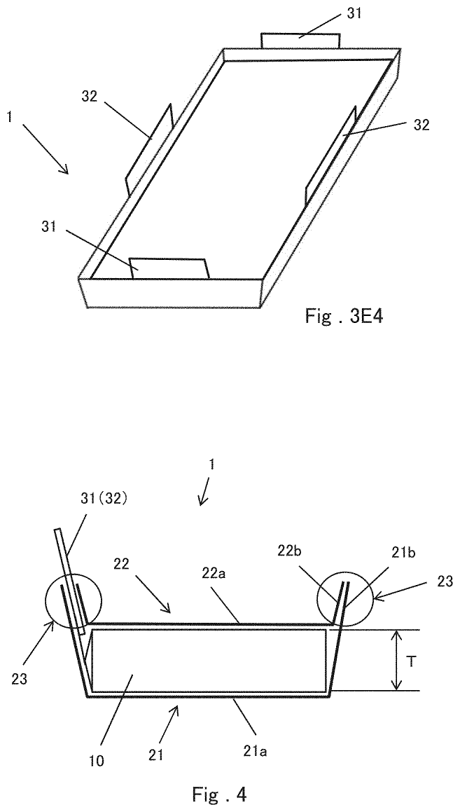

For example, as shown in FIG. 3A, the positive electrode terminal 31 and the negative electrode terminal 32 may be drawn from sides of the battery element 10 facing each other. In this case, for example, as shown in FIG. 3B, the positive electrode terminal 31 and the negative electrode terminal 32 can be drawn out from a position that is not point-symmetric with respect to the center point of the battery element 10 projected from the thickness direction. By arranging the positive terminal 31 and the negative terminal 32 in this manner, even if the positive terminal 31 and the negative terminal 32 of the film-covered battery 1 are erroneously connected to another device or another battery, they cannot be connected to other devices or batteries because of changing the draw-out positions of the terminals. As a result, a short circuit with another device or a battery can be prevented. Further, the positive electrode terminal 31 and the negative electrode terminal 32 can be drawn out from two adjacent sides of the battery element 10, as shown in FIG. 3C. Furthermore, as shown in FIG. 3D, at least one of the positive electrode terminal 31 and the negative electrode terminal 32 may be plural such that the positive electrode terminals 31 are drawn from two opposite sides of the battery element 10 and the negative terminals 32 are drawn from the remaining two opposite sides. In any case, the positive electrode tab 10a and the negative electrode tab 10b can be formed at positions corresponding to the directions in which the positive electrode terminal 31 and the negative electrode terminal 32 are drawn out.

FIGS. 3E1 to 3E4 show perspective views of the film-covered batteries 1 in which the battery elements 10 shown in FIGS. 3A to 3D are respectively sealed. FIG. 3E1 corresponds to FIG. 3A, FIG. 3E2 corresponds to FIG. 3B, FIG. 3E3 corresponds to FIG. 3C, and FIG. 3E4 corresponds to FIG. 3D. In any case, the positive electrode terminal 31 and the negative electrode terminal 32 extend from the joining portion between the first portion and the second portion of the outer package to the outside of the outer package.

Furthermore, in the illustrated embodiment, the battery element 10 having a laminated structure having a plurality of positive electrodes 11 and a plurality of negative electrodes 12 is shown. However, the battery element having the winding structure may have one positive electrode 11 and one negative electrode 12.

Referring to FIG. 1 again, the first portion 21 and the second portion 22 forming the exterior body can be formed of different films from each other. The first portion 21 has a first bottom wall 21a and a first side wall 21b rising from the outer peripheral end of the first bottom wall 21a over the entire outer peripheral end of the first bottom wall 21a. The second portion 22 has a second bottom wall 22a and a second sidewall 22b rising from the outer peripheral end of the second bottom wall 22a at least at a part of the outer peripheral end of the second bottom wall 22a. For example, in the embodiment shown in FIG. 1, the second sidewall 22b rises from the outer peripheral end of the second bottom wall 22a over the entire outer peripheral end of the second bottom wall 22a.

The rising angle of the first side wall 21b and the second sidewall 22b (the angle with respect to the bottom wall 21a and the bottom wall 22a) is preferably 30° or more, more preferably 45° or more, and further preferably 60° or more. The rising angle is preferably less than 90° since it is difficult to manufacture at a rising angle of 90° and it becomes difficult to stack film-covered batteries as described later. The rising angles of the first side wall 21b and the second sidewall 22b may be the same angle. However, for example, the rising angle of the first sidewall 21 may be larger. In this embodiment, since the film does not bend beyond 90°, damage to the metal layer in the laminate film is prevented, and the outer package having excellent sealing properties can be provided.

The size of the first bottom wall 21a and the second bottom wall 22a is the same as or slightly larger (for example, about 1 to 5 mm in longitudinal and lateral sides, preferably about 1 to 3 mm) than the size of the battery element 10 so that the battery element 10 can be accommodated. Further, the sizes of the first bottom wall 21a and the second bottom wall 22a may be different. For example, if the second bottom wall 22a is slightly larger (for example, about 1 to 6 mm in longitudinal and lateral sides) than the first bottom wall 21a, it may be easy to stack film-covered batteries as described later.

Battery element 10 is placed in the recess formed by the first bottom wall 21a and the first sidewall 21b. The first portion 21 and the second portion 22 face each other such that the battery element 10 is located between the first bottom wall 21a and the second bottom wall 22a. The orientation of the second portion 22 when the first portion 21 and the second portion 22 face each other is an orientation such that the second sidewall 22b is located farther away from the second bottom wall with respect to the battery element 10 placed in the recess of the first portion 21.

The opposed first and second portions 21 and 22 are bonded at the outer peripheral portions facing each other over the entire periphery of the first portion 21 and the second portion 22, thereby forming a joining portion on the outer package (in the attached drawings including FIG. 1, the joining portions are shaded). As shown in FIG. 4, this joining portion includes a sidewall joining portion 23 where the first and second sidewalls 21b and 22b are bonded to each other in a region where the first and second sidewalls 22b and 22b face each other. When the first portion 21 and the second portion 22 face each other as described above, the sidewall joining portion 23 is located outside the range of the thickness T of the battery element 10 in the thickness T direction of the battery element 10.

As described above, the first portion 21 and the second portion 22 are configured so that the sidewall joining portion 23 located outside the range of the thickness T of the battery element 10 is formed, and the both are bonded to each other. Thereby, the footprint of the film-covered battery 1 can be reduced.

In this embodiment, the positive electrode terminal 31 and the negative electrode terminal 32 are both drawn out of the outer package through the sidewall joining portion 23. The direction in which the positive electrode terminal 31 and the negative electrode terminal 32 are oriented outside the exterior body is arbitrary, and can be appropriately determined from the viewpoint of reducing the footprint and the ease of mounting. For example, the positive electrode terminal 31 and the negative electrode terminal 32 may be oriented to the rising direction of the first sidewall 21b and the second sidewall 22b, may be oriented more upward (in the thickness direction), or may be oriented more laterally than the rising direction of the first sidewall 21b and the second sidewall 22b. In order to make the footprint smaller, it is preferable that the positive electrode terminal 31 and the negative electrode terminal 32 do not orient at least completely in a lateral direction (parallel to a plane perpendicular to the thickness direction of the battery element 10).

As the film constituting the outer package, for example, a metal thin film having a heat-fusible resin film provided at a joining portion, or a laminated film including at least two layers of a metal thin film and a heat-fusible resin film can be used. As the metal thin film, a known material that can prevent infiltration of moisture into the inside can be used. Examples of the material include thin films such as aluminum, stainless steel, nickel, copper, and the like.

As the heat-fusible resin film, a known material that can seal the exterior body by its heat-fusibility can be used. Examples of the material include resins such as polypropylene, polyethylene, polyethylene terephthalate, and nylon.

In the present embodiment, the heat-fusible resin film of the laminate film is provided such that the heat-fusible resin film exists on the side where the first portion 21 and the second portion 22 face each other at the joining portion. In the embodiment of FIG. 1, the heat-fusible resin film is provided at least inside the sidewall 21b (inside the concave portion) in the first portion 21, and is provided at least outside the sidewall 22b (outside the concave portion) in the second portion 22.

The method of processing the shapes of the first portion 21 and the second portion 22 from the sheet of the laminated film is not particularly limited, and a press process called a drawing process (including a deep drawing process) is generally used.

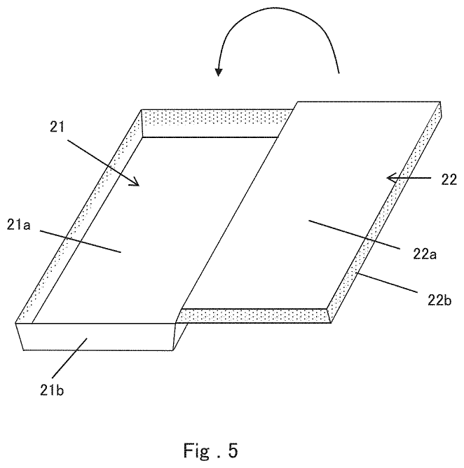

The following is a modification of the present embodiment. In the embodiment of FIG. 1, the first portion 21 and the second portion 22 that constitute the outer package are different processed films (two separated films), but the first portion 21 and the second portion 22 may be an integral film. FIG. 5 shows an example.

In FIG. 5, a first bottom wall 21a and a first sidewall 21b rising from an outer peripheral end thereof are formed as a first portion 21 on the left side of the film from one laminated film. On the other hand, in the right part of the film, a second bottom wall 22a and a second sidewall 22b rising from the outer peripheral end are formed as the second part 22. A battery element (not shown) is placed on the first bottom wall 21a and the film is bended at the boundary between the first portion 21 and the second portion 22 as shown by an arrow. Thereby, the battery element can be enclosed and a configuration similar to the embodiment of FIG. 1 can be formed.

The most preferable configuration of the present embodiment is a configuration in which the second sidewall 22b rises over the entire periphery of the outer peripheral end of the second bottom wall 22a as shown in FIGS. 1 and 5. However, even in the configuration in which the second sidewall 22b is formed only partially in the second portion 22, it is possible to suppress an increase in footprint due to the positive electrode and the negative electrode terminal, and such configuration is also suitable for configuring a battery pack and a battery module, which will be described later, similarly to the configurations shown in FIGS. 1 and 5.

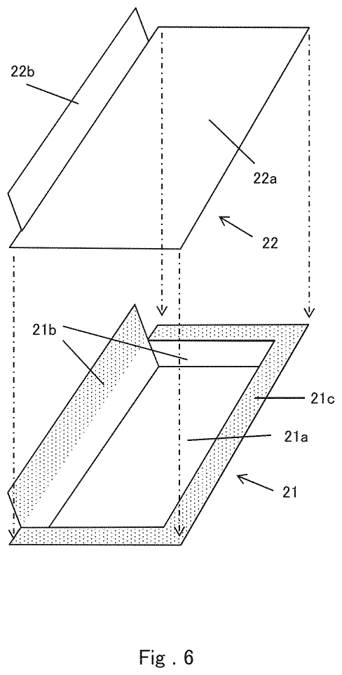

It will be specifically described with reference to FIG. 6. The first portion 21 includes a first bottom wall 21a and a first sidewall 21b rising from an outer peripheral end thereof. However, a part (three sides in this example) of the sidewall 21b has an extension wall 21c extending further outward from the sidewall. The extension wall 21c is not included in the sidewall.

The second portion 22 has the second bottom wall 22a and the second sidewall 22b formed only at a part of the outer peripheral end (a part of one side in this example). When forming the exterior body with the first portion and the second portion, the extension wall 21c of the first portion is fused to the outer periphery of the second bottom wall 22a of the second portion, and the first sidewall 21b of the first portion and the second sidewall 22b of the second portion are fused. At least one, and preferably both, of the positive terminal 31 and the negative terminal 32 drawn from the battery element 10 are drawn from a side wall joining portion formed by the first sidewall 21b and the second sidewall 22b. Therefore, an increase in footprint due to the positive electrode terminal 31 and/or the negative electrode terminal 32 can be suppressed.

[Method of Manufacturing Film-Covered Battery]

In order to manufacture the film-covered battery according to the present embodiment, first, the first portion and the second portion constituting the outer package are prepared by drawing (including deep drawing) the laminated film or the like. A separately manufactured battery element is placed so as to be located between the first bottom wall and the second bottom wall of the outer package, and the periphery is heat fused except for a part of the opening. For example, in the example of FIG. 1, the first sidewall 21a and the second sidewall 22a are heat fused while leaving a part of the sidewall. At this time, the outer body may be formed in a bag shape by performing heat fusion on the three sides first, and the battery element may be placed from the remaining one side.

Next, an electrolytic solution is injected from the opening to impregnate the electrode with the electrolytic solution. Thereafter, the opening of the outer package is sealed by heat fusion to complete the film-covered battery. According to such a manufacturing method, since there is no bending of the film after heat fusion, the damage of the metal layer in the laminated film is suppressed, and the state of the laminated film can be easily inspected before assembling the battery.

[Battery Pack and Battery Module]

The film-covered battery according to the present embodiment can be used in various configurations, and can forms a compact battery module by combining a plurality of film-covered batteries (unit cells) to configure a battery pack, and housing the in a housing as necessary.

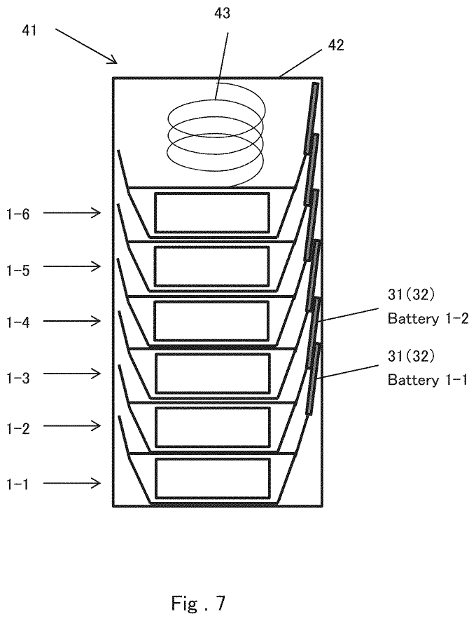

FIG. 7 shows an example of a battery pack combining film-covered batteries (unit cells) and a battery module 41 in which the battery pack is housed in a housing. This battery module 41 is an example in which six film-covered batteries 1 (1-1 to 1-6) are vertically stacked and housed in a module housing 42. The first and second sidewalls (21b and 22b) of the film-covered battery 1 rise from the first and second bottom walls (21a and 22a), respectively. Therefore, when the film-covered batteries 1 are vertically stacked, the first bottom wall 21a of the film-covered battery 1-2 rides on the second bottom wall 22a of the film-covered battery 1-1, and the film-covered batteries 1-1 to 1-6 can be sequentially stacked in the same manner.

Since the positive electrode terminal 31 and the negative electrode terminal 32 extend in the direction of the first and second sidewalls (21b and 22b) (see FIG. 4), when the film-covered batteries are stacked, the terminals (for example, between the positive terminals 31 and between the negative terminals 32) come close to or come into contact with each other as shown in FIG. 7. Therefore, the terminals can be easily connected to each other without particularly increasing the volume and the bottom area of the battery module. Generally, a gap is formed above the film-covered battery 1-6 at the uppermost part of the battery module. In this portion, a cell holding spring 43 for suppressing the rattling of the film-covered batteries may be placed, or other measuring devices for observing the battery state such as a thickness gauge and a pressure gauge, or an electronic circuit such as a protection circuit may be provided.

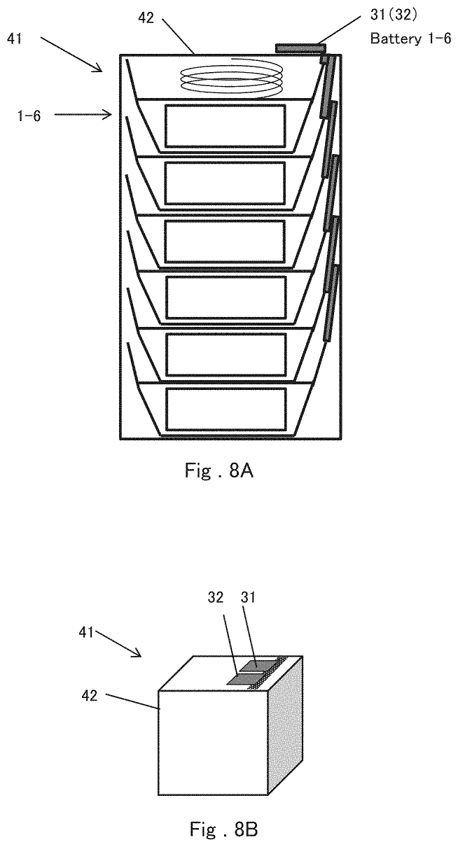

As shown in FIGS. 8A and 8B, the positive terminal 31 and the negative terminal 32 of the uppermost battery (the film-covered battery 1-6 in these figures) may be drawn out of the module housing 42, for example, to the upper surface of the module housing 42 as shown in FIG. 8B. According to this configuration, the upper gap of the film-covered battery at the top can be reduced, and the positive terminal 31 and the negative terminal 32 drawn out of the module housing 42 can be conveniently used for connection with other devices.

In the battery pack, film-covered batteries as unit cells can be connected in series, parallel, or a combination of both. By connecting in series and/or in parallel, the capacity and voltage can be adjusted freely. The number of film-covered batteries included in the battery pack can be appropriately set according to the battery capacity and output.

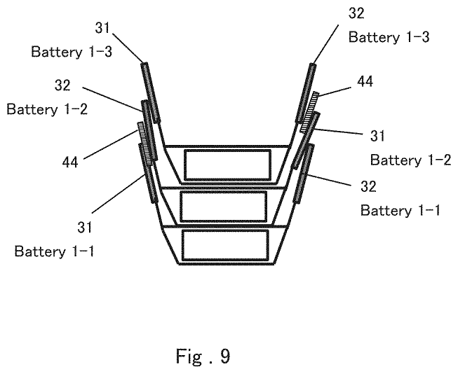

For example, the film-covered batteries shown in FIG. 1 can be connected in parallel by stacking as shown in FIG. 7 and connecting the adjacent or contacting positive terminals 31 and negative electrodes 32. Further, for example, using the film-covered battery shown in FIG. 3A, in which the positive terminal and the negative terminal are drawn out from the opposite side, as shown in FIG. 9, a plurality of film-covered batteries (in the figure, three batteries 1-1 to 1-3 are shown) are stacked so that the positive electrode and the negative electrode are alternately arranged, and the insulators 44 are combined such that the connection between the positive electrode and the negative electrode and insulation are alternated, thereby forming a series connection becomes possible. As shown in FIG. 9, the batteries 1-1 to 1-3 can be connected in series by insulating the positive electrode 31 of the battery 1-1 and the negative electrode 32 of the battery 1-2 with the insulator 44, connecting between the negative electrode 32 of the battery 1-1 and the positive electrode 31 of the battery 1-2, connecting the negative electrode 32 of the battery 1-2 to the positive electrode 31 of the battery 1-3, and insulating the positive electrode 31 of the battery 1-2 and the negative electrode 32 of the battery 1-3 with an insulator 44. Even in the case of using the film-covered battery shown in FIG. 1, a series connection is possible by alternately stacking batteries in which the positive electrode terminal and the negative electrode terminal are exchanged and using an insulator so that connection and insulation are alternated.

[Battery Components and Battery Elements]

The present invention is applicable to all batteries that can be covered with a film, and can be suitably applied to, for example, a secondary battery such as a lithium ion secondary battery. Hereinafter, the lithium ion secondary battery will be described. As described above, the battery element has a positive electrode, a negative electrode, a separator, and, if necessary, an insulating layer. Representative examples of these members and the electrolyte will be described below.

[1] Negative Electrode

The negative electrode has a structure in which, for example, a negative electrode active material is adhered to a negative electrode current collector by a negative electrode binder, and the negative electrode active material is laminated on the negative electrode current collector as a negative electrode active material layer. Any material capable of absorbing and desorbing lithium ions with charge and discharge can be used as the negative electrode active material in the present embodiment as long as the effect of the present invention is not significantly impaired. Normally, as in the case of the positive electrode, the negative electrode is also configured by providing the negative electrode active material layer on the current collector. Similarly to the positive electrode, the negative electrode may also have other layers as appropriate.

The negative electrode active material is not particularly limited as long as it is a material capable of absorbing and desorbing lithium ions, and a known negative electrode active material can be arbitrarily used. For example, it is preferable to use carbonaceous materials such as coke, acetylene black, mesophase microbead, graphite and the like; lithium metal; lithium alloy such as lithium-silicon, lithium-tin; lithium titanate and the like as the negative electrode active material. Among these, carbonaceous materials are most preferably used from the viewpoint of good cycle characteristics and safety and further excellent continuous charge characteristics. One negative electrode active material may be used alone, or two or more negative electrode active materials may be used in combination in any combination and ratio.

Furthermore, the particle diameter of the negative electrode active material is arbitrary as long as the effect of the present invention is not significantly impaired. However, in terms of excellent battery characteristics such as initial efficiency, rate characteristics, cycle characteristics, etc., the particle diameter is usually 1 μm or more, preferably 15 μm or more, and usually about 501 μm or less, preferably about 30 μm or less. Furthermore, for example, it can be also used as the carbonaceous material such as a material obtained by coating the carbonaceous material with an organic substance such as pitch or the like and then calcining the carbonaceous material, or a material obtained by forming amorphous carbon on the surface using the CVD method or the like. Examples of the organic substances used for coating include coal tar pitch from soft pitch to hard pitch; coal heavy oil such as dry distilled liquefied oil; straight run heavy oil such as atmospheric residual oil and vacuum residual oil, crude oil; petroleum heavy oil such as decomposed heavy oil (for example, ethylene heavy end) produced as a by-product upon thermal decomposition of crude oil, naphtha and the like. A residue obtained by distilling these heavy oil at 200 to 400° C. and then pulverized to a size of 1 to 1001 μm can also be used as the organic substance. In addition, vinyl chloride resin, phenol resin, imide resin and the like can also be used as the organic substance.

In one embodiment of the present invention, the negative electrode includes a metal and/or a metal oxide and carbon as the negative electrode active material. Examples of the metal include Li, Al, Si, Pb, Sn, In, Bi, Ag, Ba, Ca, Hg, Pd, Pt, Te, Zn, La, and alloys of two or more of these. These metals or alloys may be used as a mixture of two or more. In addition, these metals or alloys may contain one or more non-metal elements.

Examples of the metal oxide include silicon oxide, aluminum oxide, tin oxide, indium oxide, zinc oxide, lithium oxide, and composites of these. In the present embodiment, tin oxide or silicon oxide is preferably contained as the negative electrode active material, and silicon oxide is more preferably contained. This is because silicon oxide is relatively stable and hardly causes reaction with other compounds. Also, for example, 0.1 to 5 mass % of one or more elements selected from nitrogen, boron and sulfur can be added to the metal oxide. In this way, the electrical conductivity of the metal oxide can be improved. Also, the electrical conductivity can be similarly improved by coating the metal or the metal oxide with an electro-conductive material such as carbon by vapor deposition or the like.

Examples of the carbon include graphite, amorphous carbon, diamond-like carbon, carbon nanotube, and composites of these. Highly crystalline graphite has high electrical conductivity and is excellent in adhesiveness with respect to a negative electrode current collector made of a metal such as copper and voltage flatness. On the other hand, since amorphous carbon having a low crystallinity has a relatively small volume expansion, it has a high effect of alleviating the volume expansion of the entire negative electrode, and deterioration due to non-uniformity such as crystal grain boundaries and defects hardly occurs.

The metal and the metal oxide have the feature that the capacity of accepting lithium is much larger than that of carbon. Therefore, the energy density of the battery can be improved by using a large amount of the metal and the metal oxide as the negative electrode active material. In order to achieve high energy density, it is preferable that the content ratio of the metal and/or the metal oxide in the negative electrode active material is high. A larger amount of the metal and/or the metal oxide is preferable, since it increases the capacity of the negative electrode as a whole. The metal and/or the metal oxide is preferably contained in the negative electrode in an amount of 0.01% by mass or more of the negative electrode active material, more preferably 0.1% by mass or more, and further preferably 1% by mass or more. However, the metal and/or the metal oxide has large volume change upon absorbing and desorbing of lithium as compared with carbon, and electrical junction may be lost. Therefore, the amount of the metal and/or the metal oxide in the negative active material is 99% by mass or less, preferably 90% by mass or less, more preferably 80% by mass or less. As described above, the negative electrode active material is a material capable of reversibly absorbing and desorbing lithium ions with charge and discharge in the negative electrode, and does not include other binder and the like.

The negative electrode active material layer may be formed, for example, into a sheet electrode by roll-forming the above-described negative electrode active material, or formed into a pellet electrode by compression molding. However, usually, the negative electrode active material layer can be formed by applying and drying an application liquid on a current collector, where the application liquid may be obtained by slurrying the above-described negative electrode active material, a binding agent (binder), and various auxiliaries contained as necessary with a solvent.

The negative electrode binder is not particularly limited, and examples thereof include polyvinylidene fluoride, vinylidene fluoride-hexafluorop ropylene copolymer, vinylidene fluoride-tetrafluoroethylene copolymer, styrene-butadiene copolymer rubber, polytetrafluoroethylene, polypropylene, polyethylene, acrylic, acrylic acid, sodium acrylate, polyimide, polyamide imide and the like. In addition to the above, styrene butadiene rubber (SBR) and the like can be included. When an aqueous binder such as an SBR emulsion is used, a thickener such as carboxymethyl cellulose (CMC) can also be used. The amount of the negative electrode binder to be used is preferably 0.5 to 20 parts by mass relative to 100 parts by mass of the negative electrode active material from the viewpoint of a trade-off between “sufficient binding strength” and “high energy”. The negative electrode binders may be mixed and used.

As the material of the negative electrode current collector, a known material can be arbitrarily used, and for example, a metal material such as copper, nickel, stainless steel, aluminum, chromium, silver and an alloy thereof is preferably used from the viewpoint of electrochemical stability. Among them, copper is particularly preferable from the viewpoint of ease of processing and cost. It is also preferable that the negative electrode current collector is also subjected to surface roughening treatment in advance. Further, the shape of the current collector is also arbitrary, and examples thereof include a foil shape, a flat plate shape and a mesh shape. A perforated type current collector such as an expanded metal or a punching metal can also be used.

The negative electrode can be produced, for example, by forming a negative electrode active material layer containing a negative electrode active material and a negative electrode binder on a negative electrode current collector. Examples of a method for forming the negative electrode active material layer include a doctor blade method, a die coater method, a CVD method, a sputtering method, and the like. After forming the negative electrode active material layer in advance, a thin film of aluminum, nickel or an alloy thereof may be formed by a method such as vapor deposition, sputtering or the like to obtain a negative electrode current collector.

An electroconductive auxiliary material may be added to a coating layer containing the negative electrode active material for the purpose of lowering the impedance. Examples of the electroconductive auxiliary material include flaky, sooty, fibrous carbonaceous microparticles and the like such as graphite, carbon black, acetylene black, vapor grown carbon fiber (for example, VGCF (registered trademark) manufactured by Showa Denko K.K.), and the like.

[2] Positive Electrode

The positive electrode refers to an electrode on the high potential side in a battery. As an example, the positive electrode includes a positive electrode active material capable of reversibly absorbing and desorbing lithium ions with charge and discharge, and has a structure in which a positive electrode active material is laminated on a current collector as a positive electrode active material layer integrated with a positive electrode binder. In one embodiment of the present invention, the positive electrode has a charge capacity per unit area of 3 mAh/cm² or more, preferably 3.5 mAh/cm² or more. From the viewpoint of safety and the like, the charge capacity per unit area of the positive electrode is preferably 15 mAh/cm² or less. Here, the charge capacity per unit area is calculated from the theoretical capacity of the active material. That is, the charge capacity of the positive electrode per unit area is calculated by (theoretical capacity of the positive electrode active material used for the positive electrode)/(area of the positive electrode). Note that the area of the positive electrode refers to the area of one surface, not both surfaces of the positive electrode.

The positive electrode active material in the present embodiment is not particularly limited as long as it is a material capable of absorbing and desorbing lithium, and can be selected from several viewpoints. A high-capacity compound is preferably contained from the viewpoint of high energy density. Examples of the high-capacity compound include nickel lithate (LiNiO₂) and a lithium nickel composite oxide obtained by partially replacing Ni of nickel lithate with another metal element, and a layered lithium nickel composite oxide represented by formula (A) below is preferable.

Li_{y}Ni₍₁₋ₓ₎MₓO₂ (A)

(provided that 0≤x<1, 0<y≤1.2, and M is at least one element selected from the group consisting of Co, Al, Mn, Fe, Ti, and B.)

From the viewpoint of high capacity, the Ni content is preferably high, or that is to say, x is less than 0.5 in formula (A), and more preferably 0.4 or less. Examples of such compounds include Li_{α}Ni_{β}Co_{γ}Mn_{δ}O₂ (0<α≤1.2, preferably 1≤α≤1.2, β+γ+δ=1, β≥0.7, and γ≤0.2) and Li_{α}Ni_{β}Co_{γ}Al_{δ}O₂ (0<α≤1.2 preferably 1≤α≤1.2, β+γ+δ=1, β≥0.6 preferably β≥0.7, y≤0.2), and, in particular, LiNi_{β}Co_{γ}Mn_{δ}O₂ (0.75≤β≤0.85, 0.05≤γ≤0.15, 0.10≤δ≤0.20). More specifically, for example, LiNi_{0.8}Co_{0.05}Mn_{0.15}O₂, LiNi_{0.8}Co_{0.1}Mn_{0.1}O₂, LiNi_{0.8}Co_{0.15}Al_{0.05}O₂, and LiNi_{0.8}Co_{0.1}Al_{0.1}O₂ can be preferably used.

From the viewpoint of heat stability, it is also possible that the Ni content does not exceed 0.5, or that is to say, x is 0.5 or more in formula (A). It is also preferable that a certain transition metal does not account for more than half. Examples of such compounds include Li_{α}Ni_{β}Co_{γ}Mn_{δ}O₂ (0≤α≤1.2 preferably 1≤α≤1.2, β+γ+δ=1, 0.2≤β≤0.5, 0.1≤γ≤0.4, 0.1≤δ≤0.4). More specific examples include LiNi_{0.4}Co_{0.3}Mn_{0.3}O₂ (abbreviated as NCM433), LiNi_{1/3}Co_{1/3}Mn_{1/3}O₂, LiNi_{0.5}Co_{0.2}Mn_{0.3}O₂ (abbreviated as NCM523), and LiNi_{0.5}Co_{0.3}Mn_{0.2}O₂ (abbreviated as NCM532) (provided that these compounds include those in which the content of each transition metal is varied by about 10%).

Also, two or more compounds represented by formula (A) may be used as a mixture, and, for example, it is also preferable to use NCM532 or NCM523 with NCM433 in a range of 9:1 to 1:9 (2:1 as a typical example) as a mixture. Moreover, a battery having a high capacity and a high heat stability can be formed by mixing a material having a high Ni content (x is 0.4 or less) with a material having a Ni content not exceeding 0.5 (x is 0.5 or more, such as NCM433) in formula (A).

Other than the above positive electrode active materials, examples include lithium manganates having a layered structure or a spinel structure, such as LiMnO₂, LiₓMn₂O₄ (0<x<2), Li₂MnO₃, and LiₓMn_{1.5}Ni_{0.5}O₄ (0<x<2); LiCoO₂ and those obtained by partially replacing these transition metals with other metals; those having an excess of Li based on the stoichiometric compositions of these lithium transition metal oxides; and those having an olivine structure such as LiFePO₄. Moreover, materials obtained by partially replacing these metal oxides with Al, Fe, P, Ti, Si, Pb, Sn, In, Bi, Ag, Ba, Ca, Hg, Pd, Pt, Te, Zn, La, or the like can be used as well. One of the positive electrode active materials described above may be used singly, or two or more can be used in combination.

Similar to the negative electrode active material layer, the positive electrode active material layer may be, for example, formed into a sheet electrode by roll-forming the above-described positive electrode active material, or formed into a pellet electrode by compression molding. However, usually, the positive electrode active material layer can be formed by applying and drying an application liquid on a current collector, where the application liquid may be obtained by slurrying the above-described positive electrode active material, a binding agent (binder), and various auxiliaries contained as necessary with a solvent.

As the binder for the positive electrode, a material similar to the binder for the negative electrode can be used. Among them, polyvinylidene fluoride or polytetrafluoroethylene is preferable from the viewpoint of versatility and low cost, and polyvinylidene fluoride is more preferable. The amount of the positive electrode binder used is preferably 2 to 15 parts by mass relative to 100 parts by mass of the positive electrode active material from the viewpoint of a trade-off between “sufficient binding strength” and “high energy”.

An electroconductive auxiliary material may be added to a coating layer containing the positive electrode active material for the purpose of lowering the impedance. Examples of the conductive auxiliary material include flaky, sooty, fibrous carbonaceous microparticles and the like such as graphite, carbon black, acetylene black, vapor grown carbon fiber (for example, VGCF manufactured by Showa Denko K.K.) and the like.

As the positive electrode current collector, a material similar to the negative electrode current collector can be used. In particular, as the positive electrode, a current collector using aluminum, an aluminum alloy, iron, nickel, chromium, molybdenum type stainless steel is preferable.

An electroconductive auxiliary material may be added to the positive electrode active material layer containing the positive electrode active material for the purpose of lowering the impedance. Examples of the conductive auxiliary material include graphite, carbon black, acetylene black and the like.

[3] Insulating Layer

The insulating layer is porous and has a structure in which non-conductive particles are bonded by a binder. As the non-conductive particles, for example, various inorganic particles, organic particles and other particles can be used. Among them, inorganic oxide particles or organic particles are preferable, and in particular, from the viewpoint of high thermal stability of the particles, it is more preferable to use inorganic oxide particles.

Examples of the inorganic particles include inorganic oxide particles such as aluminum oxide, silicon oxide, magnesium oxide, titanium oxide, BaTiO₂, ZrO, alumina-silica composite oxide; inorganic nitride particles such as aluminum nitride and boron nitride; covalent crystal particles such as silicon, diamond and the like; sparingly soluble ionic crystal particles such as barium sulfate, calcium fluoride, barium fluoride and the like; clay fine particles such as talc and montmorillonite. These particles may be subjected to element substitution, surface treatment, solid solution treatment, etc., if necessary, and may be used singly or in combination of two or more kinds. Among them, inorganic oxide particles are preferable from the viewpoints of stability in the electrolytic solution and potential stability.

The shape of the non-conductive particles is not particularly limited, and may be spherical, needle-like, rod-like, spindle-shaped, plate-like, or the like. When the shape of the non-conductive particles is spherical, the average particle diameter of the non-conductive particles is preferably in the range of 0.005 to 10 μm, more preferably 0.1 to 5 μm, particularly preferably 0.3 to 2 μm.

When the solvent contained in an insulating layer slurry for forming the insulating layer is a non-aqueous solvent, a polymer dispersed or dissolved in a non-aqueous solvent can be used as a binder. As the polymer dispersed or dissolved in the non-aqueous solvent, polyvinylidene fluoride (PVdF), polytetrafluoroethylene (PTFE), polyhexafluoropropylene (PHFP), polytrifluoroethylene chloride (PCTFE), polyperfluoroalkoxyfluoroethylene, polyimide, polyamideimide, and the like can be used as a binder, and it is not limited thereto. In addition, a binder used for binding the active material layer can also be used.

When the solvent contained in the slurry for insulating layer is an aqueous solvent (a solution using water or a mixed solvent containing water as a main component as a dispersion medium of the binder), a polymer dispersed or dissolved in an aqueous solvent can be used as a binder. A polymer dispersed or dissolved in an aqueous solvent includes, for example, an acrylic resin. As the acrylic resin, it is preferably to use homopolymers obtained by polymerizing monomers such as acrylic acid, methacrylic acid, acrylamide, methacrylamide, 2-hydroxyethyl acrylate, 2-hydroxyethyl methacrylate, methyl methacrylate, ethylhexyl acrylate, butyl acrylate. The acrylic resin may be a copolymer obtained by polymerizing two or more of the above monomers. Further, two or more of the homopolymer and the copolymer may be mixed. In addition to the above-mentioned acrylic resin, polyolefin resins such as styrene butadiene rubber (SBR) and polyethylene (PE), polytetrafluoroethylene (PTFE), and the like can be used. These polymers can be used singly or in combination of two or more kinds. Among them, it is preferable to use an acrylic resin. The form of the binder is not particularly limited, and particles in the form of particles (powder) may be used as they are, or those prepared in a solution state or an emulsion state may be used. Two or more kinds of binders may be used in different forms.

The insulating layer may contain a material other than the above-described non-conductive filler and binder, if necessary. Examples of such material include various polymer materials that can function as a thickener for the insulating layer slurry. In particular, when an aqueous solvent is used, it is preferable to contain a polymer functioning as the thickener. As the polymer functioning as the thickener, carboxymethyl cellulose (CMC) or methyl cellulose (MC) is preferably used.

Although not particularly limited, the ratio of the non-conductive filler to the entire insulating layer is suitably about 70 mass % or more (for example, 70 mass % to 99 mass %), preferably 80 mass % or more (for example, 80 mass % to 99 mass %), and particularly preferably about 90 mass % to 95 mass %.

The ratio of the binder in the insulating layer is suitably about 1 to 30 mass % or less, preferably 5 to 20 mass % or less. In the case of containing an insulating layer-forming component other than the inorganic filler and the binder, for example, a thickener, the content ratio of the thickener is preferably about 10 mass % or less, more preferably about 7 mass % or less. If the ratio of the binder is too small, strength (shape retentivity) of the insulating layer itself and adhesion to the active material layer are lowered, which may cause defects such as cracking and peeling. If the ratio of the binder is too large, gaps between the particles of the insulating layer become insufficient, and the ion permeability in the insulating layer may decrease in some cases.

In order to maintain ion conductivity, the porosity (void ratio) (the ratio of the pore volume to the apparent volume) of the insulating layer is preferably 20% or more, more preferably 30% or more. However, if the porosity is too high, falling off or cracking of the insulating layer due to friction or impact applied to the insulating layer occurs, the porosity is preferably 80% or less, more preferably 70% or less.

The porosity can be calculated from the ratio of the materials constituting the insulating layer, the true specific gravity and the coating thickness.

The thickness of the insulating layer is preferably 1 μm or more and 30 μm or less, and more preferably 2 μm or more and 15 μm or less.

[4] Electrolytic Solution

The electrolytic solution includes, but are not particularly limited, a nonaqueous electrolytic solution which is stable at an operating potential of the battery. Specific examples of the nonaqueous electrolytic solution include nonprotic organic solvent such as cyclic carbonates such as propylene carbonate (PC), ethylene carbonate (EC), fluoroethylene carbonate (FEC), t-difluoroethylene carbonate (t-DFEC), butylene carbonate (BC), vinylene carbonate (VC), vinylethylene carbonate (VEC); chain carbonates such as allylmethyl carbonate (AMC), dimethyl carbonate (DMC), diethyl carbonate (DEC), ethylmethyl carbonate (EMC), dipropyl carbonate (DPC); propylene carbonate derivative; aliphatic carboxylic acid esters such as methyl formate, methyl acetate, ethyl propionate; cyclic esters such as Q-butyrolactone (GBL). The nonaqueous electrolytic solution may be used singly or a mixture of two or more kinds may be used in combination. Furthermore, sulfur-containing cyclic compound such as sulfolane, fluorinated sulfolane, propane sultone or propene sultone may be used.

Specific examples of support salt contained in the electrolytic solution include, but are not particularly limited to, lithium salt such as LiPF6, LiAsF6, LiAlCl4, LiClO4, LiBF4, LiSbF6, LiCF3SO3, LiC4F9SO3, Li(CF3SO2)2, LiN(CF3SO2)2. The support salt may be used singly or two or more kinds thereof may be used in combination.

The electrolytic solution may further include an additive. Examples of the additive include, but are not particularly limited to, halogenated cyclic carbonate, unsaturated cyclic carbonate, acid anhydride, and cyclic or linear disulfonic acid ester. By adding these compounds, battery characteristics such as cycle characteristics can be improved. This is presumed to be because these additives are decomposed during charge and discharge of the lithium ion secondary battery to form a film on the surface of the electrode active material, thereby suppressing the decomposition of the electrolytic solution and the supporting salt.

[5] Separator

When the battery element 10 includes the separator 13 between the positive electrode 11 and the negative electrode 12, the separator is not particularly limited, and porous film or non-woven fabric made of such as polypropylene, polyethylene, fluorine-based resin, polyamide, aromatic polyamide, polyimide, polyester, polyphenylene sulfide, polyethylene terephthalate, cellulose, as well as an article in which inorganic substance such as silica, alumina, glass is attached or bonded to a base material made of the above material and an article singly processed from the above material as non-woven fabric or cloth may be used as the separator. The thickness of the separator may be arbitrary. However, from the viewpoint of high energy density, a thin separator is preferable and the thickness can be, for example, 10 to 301 μm.

[Battery Usage]

The film-covered battery according to the present invention, the battery pack and the battery module combining the film-covered battery according to the present invention may be further connected in series and/or in parallel. The series number and parallel number of the batteries can be appropriately selected according to the intended voltage and capacity of the battery pack.

[Vehicle]

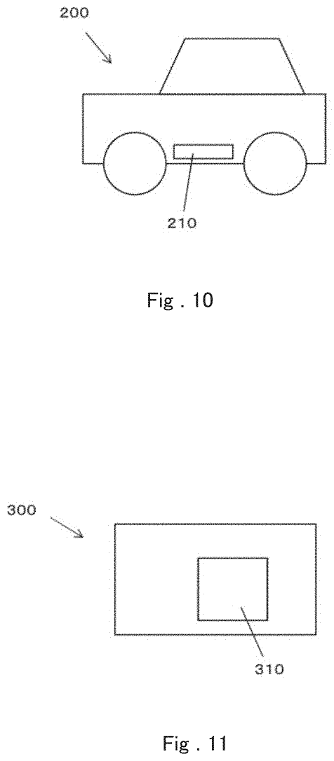

The above-described film-covered battery, the battery pack and the battery module can be used for a vehicle. Examples of vehicles that can use the film-covered battery, the battery pack and the battery module include hybrid vehicles, fuel cell vehicles, and electric vehicles (four-wheel vehicles (commercial vehicles such as passenger cars, trucks and buses, and mini-vehicles, etc.), motorcycles (motorbike and tricycles). Note that the vehicle according to the present embodiment is not limited to an automobile, and the battery can also be used as various power sources for other vehicles, for example, transportations such as trains, ships, submarines, satellites and the like. As an example of such a vehicle, FIG. 10 shows a schematic diagram of an electric vehicle. The electric vehicle 200 shown in FIG. 10 has a battery pack 210 configured to satisfy the required voltage and capacity by connecting a plurality of the above-described batteries in series and in parallel.

[Power Storage Device]

The above-described film-covered battery, the battery pack and the battery module can be used for a power storage device. Examples of the power storage device using the secondary battery or the battery pack include a power storage device which is connected between a commercial power supply supplied to an ordinary household and a load such as a household electric appliance to use as a backup power source or an auxiliary power source in case of power outage, and a power storage device used for large-scale electric power storage for stabilizing electric power output with large time variation due to renewable energy such as photovoltaic power generation. An example of such a power storage device is schematically shown in FIG. 11. The power storage device 300 shown in FIG. 11 has a battery pack 310 configured to satisfy a required voltage and capacity by connecting a plurality of the above-described batteries, the battery packs and the battery modules in series and in parallel.

[Others]

Furthermore, the above-described battery or the battery pack thereof can be used as a power source of a mobile device such as a mobile phone, a notebook computer and the like.

### Example

Next, a specific example of the film-covered battery will be described. The embodiment is not limited to this description, and those skilled in the art can make changes in materials and dimensions and other changes in accordance with the disclosure in the present specification and the common technical knowledge.

<Manufacturing of Film-Covered Battery>

Positive electrodes, negative electrodes, and separators are laminated to produce a battery element having a thickness of about 8 mm. The length of the positive electrode terminal and the negative electrode terminal drawn out from one side of the battery element is about 25 mm.

Using an aluminum laminated film having a four-layer structure of polyethylene terephthalate/nylon/aluminum/polypropylene, the first portion 21 of the outer package is formed by performing deep drawing on a shape in which the first sidewall 21b rises about 17 mm at an angle of about 60° from four sides of the rectangular first bottom wall 21a so that the polypropylene side is concave and the first bottom wall 21a is slightly larger than the battery element,

Similarly, using an aluminum laminate film having a four-layer structure of polyethylene terephthalate/nylon/aluminum/polypropylene, the second portion 22 of the outer package is formed by performing deep drawing on a shape in which the second sidewall 22b rises about 8 mm at an angle of about 60° from the four sides of the rectangular second bottom wall 22a so that the polyethylene terephthalate side is concave and the second bottom wall 22a is slightly larger (for example, about 3 to 5 mm in length and width) than the first bottom wall 21a.

The battery element 10 is placed on the first bottom wall 21a of the concave portion of the first portion 21, and then the second bottom wall 22a is placed on the battery element 10 such that the concave portion of the second portion 22 faces upward. At this time, the heights of the upper ends of the first side wall 21b and the second sidewall 22b are substantially the same.

While the first sidewall 21b and the second sidewall 22b are held together by using a jig, three sides are heat fused with a width of about 8 mm. After injecting the electrolytic solution from one unfused side, the remaining one side is heat fused to complete the film-covered battery 1.

The film-covered batteries are stacked, and the positive electrode terminal and the negative electrode terminal are connected in series and/or in parallel to produce an battery pack. Further, a battery module is produced by housing the battery pack in a housing, providing a cell holding spring if necessary, and combining a measuring device or an electronic circuit.

### INDUSTRIAL APPLICABILITY

The secondary battery (the film-covered battery, the battery pack and the battery module) according to the present invention can be utilized in, for example, any industrial field where a power source is required and industrial field relating to the transport, storage, and supply of electrical energy. Specifically, it can be utilized for power sources of mobile devices such as cell phones and notebook computers; power sources of movement/transport media such as trains, satellites, and submarines, including electric vehicles such as electric automobiles, hybrid cars, electric motorcycles, and electrically assisted bicycles; backup power sources such as UPSs; power storage facilities that store electric power produced by solar power production, wind power production, and the like; etc.

### EXPLANATION OF SYMBOLS

1 Film-covered battery
10 Battery element
10a Positive electrode tab
10b Negative electrode tab
11 Positive electrode
12 Negative electrode
21 First portion
21a First bottom wall
21b First sidewall
22 Second portion
22a Second bottom wall
22b Second sidewall
31 Positive electrode terminal
32 Negative electrode terminal
41 Battery module
42 Module housing

1. A film-covered battery comprising:
a battery element including at least one positive electrode and at least one negative electrode, and
an outer package made of a film configured to seal the battery element together with an electrolyte,
wherein the outer package comprises
(a) a first portion having a first bottom wall and a first side wall rising from an outer peripheral end of the first bottom wall over an entire outer peripheral end of the first bottom wall,
(b) a second portion having a second bottom wall and a second sidewall rising from an outer peripheral end at least at a part of the outer peripheral end of the second bottom wall, and
(c) a joining portion in which outer peripheral portions of the first portion and the second portion are joined to each other in a state where the battery element is located between the first bottom wall and the second bottom wall and the first portion and the second portion face each other, wherein the joining portion includes a sidewall joining portion in which the first sidewall and the second sidewall are joined and located outside a thickness range of the battery element.

2. The film-covered battery according to claim 1, further comprising a positive electrode terminal and a negative electrode terminal connected to the battery element, and
wherein at least one of the positive electrode terminal and the negative electrode terminal is drawn out of the outer package through the sidewall joining portion.

3. The film-covered battery according to claim 1, wherein the second sidewall rises from the outer peripheral end over the entire outer peripheral end of the second bottom wall.

4. The film-covered battery according to claim 1, wherein the first bottom wall and the second bottom wall have a rectangular shape in a plan view.

5. The film-covered battery according to claim 1, wherein the first portion and the second portion are formed of different films.

6. The film-covered battery according to claim 1, wherein the first portion and the second portion are formed of a single film.

7. The film-covered battery according to claim 1, wherein the film is a laminated film having a metal layer and a heat-fusible resin layer laminated on the metal layer.

8. A battery pack comprising:
a plurality of the film-covered batteries according to claim 1 are stacked and connected in series and/or in parallel.

9. A battery module, wherein the battery pack according to claim 8 is housed in a module housing.

10. A method for manufacturing a film-covered battery, the method comprising:
arranging a positive electrode and a negative electrode to face each other to configure a battery element,
enclosing the battery element in an outer package, and
injecting an electrolytic solution into the outer package,
wherein the outer package comprises
(a) a first portion having a first bottom wall and a first side wall rising from an outer peripheral end of the first bottom wall over an entire outer peripheral end of the first bottom wall,
(b) a second portion having a second bottom wall and a second sidewall rising from an outer peripheral end at least at a part of the outer peripheral end of the second bottom wall, and
(c) a joining portion in which outer peripheral portions of the first portion and the second portion are joined to each other in a state where the battery element is located between the first bottom wall and the second bottom wall and the first portion and the second portion face each other, and
wherein the joining portion includes a sidewall joining portion in which the first sidewall and the second sidewall are joined and located outside a thickness range of the battery element.
